(19) United States
(12) Patent Application Publication
(10) Pub. No.: US 2023/0275411 A1
(43) Pub. Date: Aug. 31, 2023

(54) DOCKING UNIT, CHARGING SYSTEM, AND METHOD OF INSTALLATION

(71) Applicant: BRIXCELL LTD, Cirencester Gloucestershire (GB)

(72) Inventors: Timothy Gardner, Cirencester Gloucestershire (GB); Bernard Glover, Cirencester Gloucestershire (GB); William McFarlane, Cirencester Gloucestershire (GB)

(21) Appl. No.: 18/016,535

(22) PCT Filed: Jul. 14, 2021
(86) PCT No.: PCT/GB2021/051817

§ 371 Date: Jan. 17, 2023

(30) Foreign Application Priority Data
Jul. 15, 2020 (GB) 2010905.4

(51) Int. Cl. H02G 3/08; H02G 3/16; H02J 7/00; B60L 53/16; B60L 53/30

(52) U.S. Cl. CPC H02G 3/081; H02G 3/16; H02J 7/0042; B60L 53/16; B60L 53/30

(57) ABSTRACT

A charging system for installation into a block wall includes a docking unit, a cover unit and a charging unit. The docking unit includes a docking unit hollow body with an open front face, and a back plate closing the rear face and an electrical connector positioned within the docking unit hollow body. The cover unit includes a cover unit hollow body for insertion into the docking unit hollow body. The charging unit has a charging unit hollow body for insertion into the docking unit hollow body; and a charger module is located in the charger housing and the charging module includes contacts for connecting to the docking unit electrical connector, and a cable connector for connecting a charging cable. A method of installing the charging system in a block wall, comprises constructing the wall; installing the docking unit; attaching a cover unit the docking unit; and subsequently removing the cover unit from the docking unit and attaching a charging unit to the docking unit so that the charger module contacts engage the contacts on the docking unit electrical connector.

### TECHNICAL FIELD

The present invention relates to a docking unit, a cover unit, and a charging unit, and to a system comprising a combination of such units. A charging system of this type can be used for charging an electric vehicle.

### BACKGROUND

With the increasing popularity of electric vehicles, it has become desirable to provide buildings, especially residential buildings, with charging points to allow such vehicles to be charged while they are parked nearby. Certain authorities are mandating that newly built residential properties shall be provided with the facility for installation of a charging unit for this purpose.

One approach is to fit a charging unit to an external wall. In order to do this, it is necessary to connect though the wall to the domestic electricity supply. However, this would require a charging unit to be installed whether or not it was needed. Examples of such charging units can be found in EP2548759 and GB2482952.

Housing units for electrical systems that can be accessible from outside a property have been proposed in other areas. The well-known “meter box” for example, provides external access to a power supply before it enters the building. GB2516880 and U.S. Pat. No. 5,573,321 describe box like structures that can be built into a wall and provided with an access door so that the internal components can be accessed without needing to enter the building. The walls are often made from bricks or blocks. While the materials and dimensions of bricks and blocks may vary, the term “block” is used in this document to cover any of these variants.

There have been various other proposals for mounting junction boxes or working boxes in walls or panels. WO2017/155855 describes a junction box that has a perimeter flange at its outer edge and mounting tabs at the rear of the box by which it can be installed on a wall or ceiling. U.S. Pat. No. 7,582,827 describes an adjustable electrical box that is secured to a wall by means of L-shaped anchoring members that can be connected to the box to allow the position to be adjusted. JP2004242434 describes a junction box that has a flange at the rear to allow it to be mounted though a hole in a panel. US2002/0125247 describes an electrical wiring box having an outer flange. The box can be installed into a brick wall and can have a cover to conceal the internal components.

This invention aims to provide a system that allows for easy installation into a wall structure, especially a brick or block wall, and which does not require all of the components of the charging point to be present until needed so as to reduce initial cost.

### SUMMARY

One aspect of the present invention provides docking unit for mounting in a block wall, comprising:
a docking unit hollow body for incorporation into a block wall, the docking unit hollow body having a substantially rectangular profile with first opposed (top and bottom) walls, second opposed (side) walls, an open (front) face, and a closed (rear face), wherein:
   the outer surfaces of the first opposed (top and bottom) walls each have a plurality of upstanding ridges, each ridge extending in a face to face (front to back) or side to side direction (the side walls may also have front to back ridges);
   the closed (rear) face of the docking unit hollow body is closed by a back plate having an opening to allow an electric supply cable to be fed into the docking unit hollow body; and
   the backplate defines a flange extending around the outside of the docking unit hollow body beyond the first and second opposed (top, bottom, and side) walls, wherein the flange extends further from the first and second opposed walls than the upstanding ridges; and
an electrical connector positioned within the docking unit hollow body and having connectors for connection to the electric supply cable, and contacts for connection to a charging unit.

The terms “top”, “bottom”, “side”, “front”, and “rear” used in this document are relative to the orientation of the unit when used in a vertical wall having an inner and outer face. In practice, the unit can be installed in any orientation appropriate for its specific use.

The docking unit hollow body can approximate to a rectangular cuboid, and can have dimensions (height, width, and depth) corresponding to that of single or multiple blocks in the block wall.

The docking unit hollow body can further comprise anchor points to which a cover unit or charging unit can be secured, such as screw anchors located in the corners of the docking unit hollow body.

The electrical connector opening in the back plate can be offset to one side of the back plate, and the electrical connector offset to the other side of the back plate. The opening can be one of a pair of openings disposed symmetrically about the centre of the docking unit hollow body so that the electrical connector can be installed on either side of the docking unit. The contacts of the electrical connector for connection to a charging unit can face the open front face of the docking unit hollow body.

Another aspect of the invention provides a cover unit for use with the docking unit, comprising:
a cover unit hollow body for insertion into the docking unit hollow body through the open (front) face of the docking unit, the cover unit hollow body having a substantially rectangular profile with first opposed (top and bottom) walls, second opposed (side) walls, an open (rear) face, and a closed (front) face, wherein:
the outer surfaces of the first and second opposed (top, bottom, and side) walls have aligned upstanding ridges extending in a direction from the closed (front) face towards the open (rear) face, and
a front plate defines the closed (front) face and provides a flange extending around the cover unit hollow body beyond the first and second opposed (top, bottom, and side) walls of the cover unit hollow body, wherein the flange extends further from the first and second opposed walls than the upstanding ridges;

wherein when the cover unit hollow body is inserted into the docking unit hollow body:
the aligned ridges on the walls of the cover unit hollow body engage inner surfaces of the docking unit hollow body first and second opposed (top, bottom, and side) walls; and
the docking unit electrical connector extends into the cover unit hollow body through the open (rear) face.

The depth of the cover unit hollow body from the cover unit front plate to the open (rear) face can be less than the depth of the docking unit hollow body from the docking unit open (front) face to the docking unit back plate. The relative depths of the hollow bodies can be selected so as to allow a range of block wall thicknesses to be accommodated.

When installed in a wall, the front plate can be visible externally on the surface of the block wall. A decorative panel can be provided on the outer surface of the front plate which can comprise locating holes for alignment with anchor points in the docking unit.

A further aspect of the invention provides charging unit for use with the docking unit, comprising:
a charging unit hollow body having a substantially rectangular profile for insertion into the docking unit hollow body through the open (front) face, the charging unit hollow body having first opposed (top and bottom) walls, second opposed (side) walls, an open (rear) face, and a closed front face including an opening into the charging unit hollow body, wherein:
   the outer surfaces of the first and second opposed (top, bottom and side) walls each have a plurality of aligned upstanding ridges extending from the closed (front) face towards the open (rear face), and
   the closed (front) face is closed by a front plate that includes a charger housing extending beyond the first and second opposed (top, bottom, and side) walls of the cover unit hollow body; and
   a charger module is located in the charger housing and extends through the opening in the front plate into the charging unit hollow body, the charging module including contacts for connecting to the docking unit electrical connector, and a cable connector for connecting a charging cable;
wherein, when the charging unit hollow body is inserted into the docking unit hollow body:
   the aligned ridges engage inner surfaces of the docking unit hollow body (top, bottom and side) walls;
   the docking unit electrical connector extends into the cover unit hollow body through the open (rear) face; and
   the charger module contacts engage the contacts on the docking unit electrical connector.

The front plate can include a channel for holding a charging cable, and two outward facing sockets, one for connection of one end a charging cable to the charger module, and the other for stowing the other end of the charging cable to the charging unit when not in use. Alternatively, both outward facing sockets can be for connection to the charger module.

The depth of the charging unit hollow body from the charging unit front plate to the open (rear) face can be less than the depth of the docking unit hollow body from the docking unit open (front) face to the docking unit back plate. The relative (front to rear) depths of the hollow bodies can be selected so as to allow a range of wall thicknesses to be accommodated.

The front plate can comprise locating holes for alignment with anchor points in the docking unit.

A still further aspect of the invention provides a method of installing a charging system in a block wall, comprising:
constructing the wall from a series of blocks;
installing a docking unit in the wall in place of a block;
feeding an electrical supply cable through the opening in the docking unit back plate and connecting the electrical cable to the connectors of the electrical connector in the docking unit; and
attaching a cover unit to the open (front) face of the docking unit;

wherein the method subsequently comprises:
removing the cover unit from the docking unit; and
attaching a charging unit to the docking unit so that the charger module contacts engage the contacts on the docking unit electrical connector.

The relative (front to rear) depths of the hollow bodies can be selected so as to allow the contacts to engage for a range of wall thicknesses.

Further aspects of the invention will be apparent from the following detailed description.

### DESCRIPTION OF DRAWINGS

FIG. 1 shows a perspective view of a docking unit.

FIG. 2 shows a front view of the docking unit of FIG. 1.

FIG. 3 shows a cross-section on line A-A of FIG. 2.

FIG. 4 shows a schematic front view corresponding to FIG. 2 showing the mounting of a connector block.

FIG. 5 shows a perspective view of a cover unit.

FIG. 6 shows a front view of the cover unit of FIG. 5.

FIG. 7 shows a rear view of the cover unit of FIG. 5.

FIG. 8 shows a cross-section on line A-A of FIG. 7.

FIG. 9 shows a perspective view of a docking unit, a cover unit, and a charging unit.

FIG. 10 shows a front view of the charging unit of FIG. 9.

FIG. 11 shows a front view of the charging unit of FIG. 9 with the cover removed and parts omitted for clarity.

FIG. 12 shows a rear view of a charging unit of FIG. 11.

FIG. 13 shows a cross-section view of a charging unit with a charging module installed in a docking unit.

FIG. 14 shows the charger module of the charging unit of FIG. 13.

FIG. 15 shows a docking unit with a cover unit installed in a wall.

### DETAILED DESCRIPTION

The Figures show various parts of a system for installing an electrical accessory such as a charging point for an electric vehicle in a block wall. The term “block wall” is used to indicate a wall constructed of multiple units such as bricks or blocks arranged in an overlapping manner and secured to each other around their joints. In many cases, the bricks or block are joined using a cement mortar. The various parts of the system are described using terms (e.g. “front, “rear”, “top”, “bottom”, “side”, etc.) in relation to a typical orientation when installed in a block wall. In some cases, the units may be installed in different orientations in a wall such that, for example, a part indicated as “bottom” may be uppermost. These terms are relative and are used for ease of understanding.

The system comprises a docking unit that can be built into a wall and connected to a supply of electricity. A cover unit can be used to close the docking unit if the charging point or other accessory is not to be installed immediately. In this way, the docking unit can be built into the wall, but it is not necessary to immediately install the charging unit or other accessory. Instead, the cover unit can be used to close the docking unit until the charging unit or other accessory is ready for installation. At this time, the cover unit can be removed, and the charging unit or other accessory installed in the docking unit. If appropriate, the charging unit or other accessory can be installed immediately in which case the cover unit is not required.

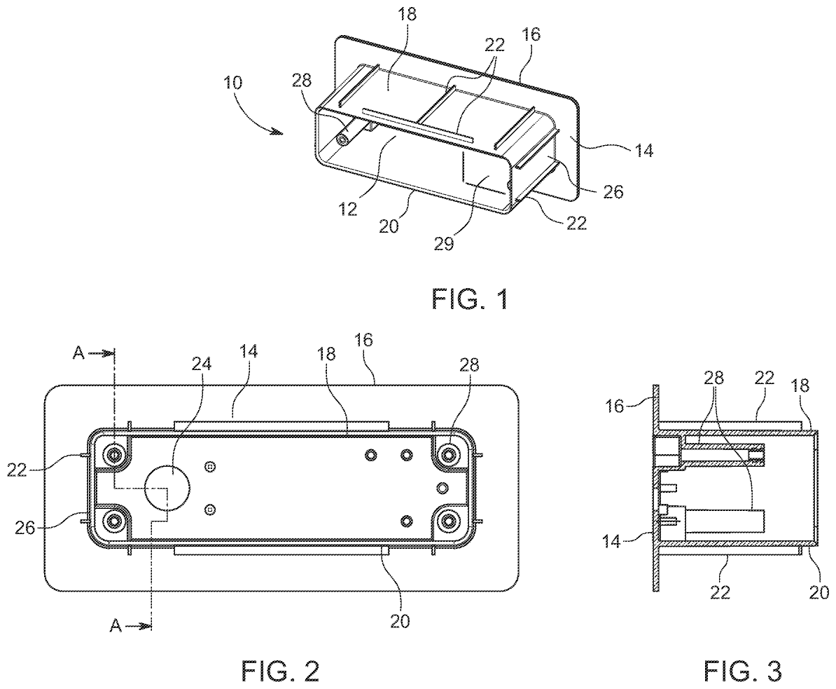

The docking unit shown in FIGS. 1-4 provides a base unit in the form of a plastic moulding that can be installed in a wall of a building to provide the capability to install a charger unit, either immediately, or at some later date. The docking unit 10 has a hollow body 12 in the form of an open-fronted box that is approximately rectangular in shape and has dimensions that correspond to a standard building block, such as a house brick. Such bricks typically have sizes in the range 195-250 mm×92-120 mm×54-76 mm. The rear of the hollow body 12 is closed by a back plate 14 that also forms a flange 16 around the outside of the hollow body 12. For the range of house brick sizes mentioned above, the flange will typically extend by around 25 mm from the outer limits of the hollow body 12.

The outer surfaces of the top 18, bottom 20, and sides 26 of the hollow body 12 have upstanding ridges 22 that can key into mortar used to make the block wall and resist displacement of the docking unit form the wall in use. The ridges on the top and bottom are shown extending front to back, and side to side. Other suitable angled configurations can be used. The height of the ridges 22 from the outer surfaces is less than the extent of the flange 16 form the outer surfaces, i.e. the flange 16 extends further than the ridges 22. This allows the ridges 22 to be completely enclosed on the joint and the flange 16 to be able to completely cover the joint around the unit.

The back plate 14 has an opening 24 offset to one side to allow an electrical supply cable (not shown) to be introduced from within the building to provide a connection for a changing unit as will be described further below. In other embodiments, two openings are provided so that installing the docking unit in different orientations still allows the supply cable to be introduced and connected properly. The two openings can be disposed symmetrically about the centre of the back plate 14.

Anchor formations 28 are provided in the hollow body 12 at the corners between the top 18, bottom 20, and sides 26. The anchor formations 28 are in the form of threaded bores that extend from the back plate 14 and open towards the front of the hollow body to receive locating screws or bolts. The anchor formations can also serve as supports for other components such as circuit boards.

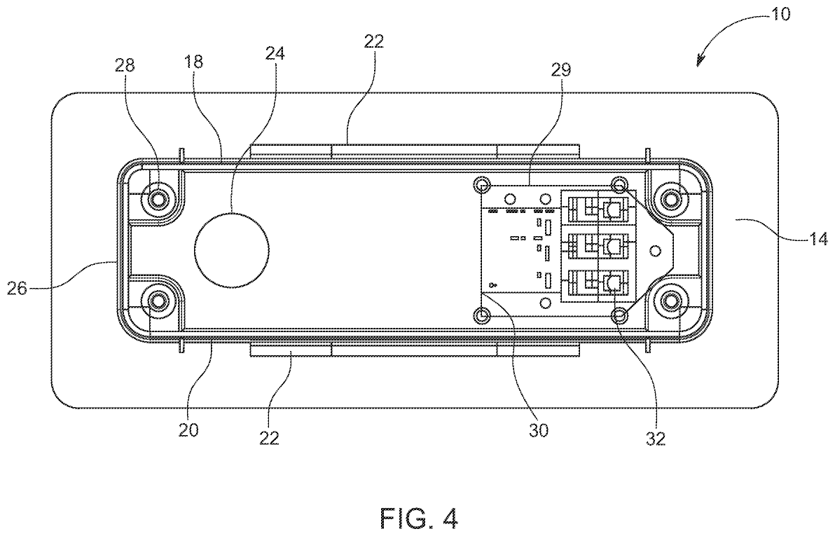

FIG. 4 shows a schematic view corresponding to FIG. 2 with an electrical connector module 29 located within the hollow body 12 to one side of the opening 24 (not shown in FIGS. 2 and 3).

The electrical connector module 29 has connectors 30 for connection to the electrical supply cable, and contacts 32 for connection to a charging module. The contacts 32 for connection to the charging module (or other future accessory) are positioned on the front of the connector module 29 so as to be accessible from the front of the hollow body 12.

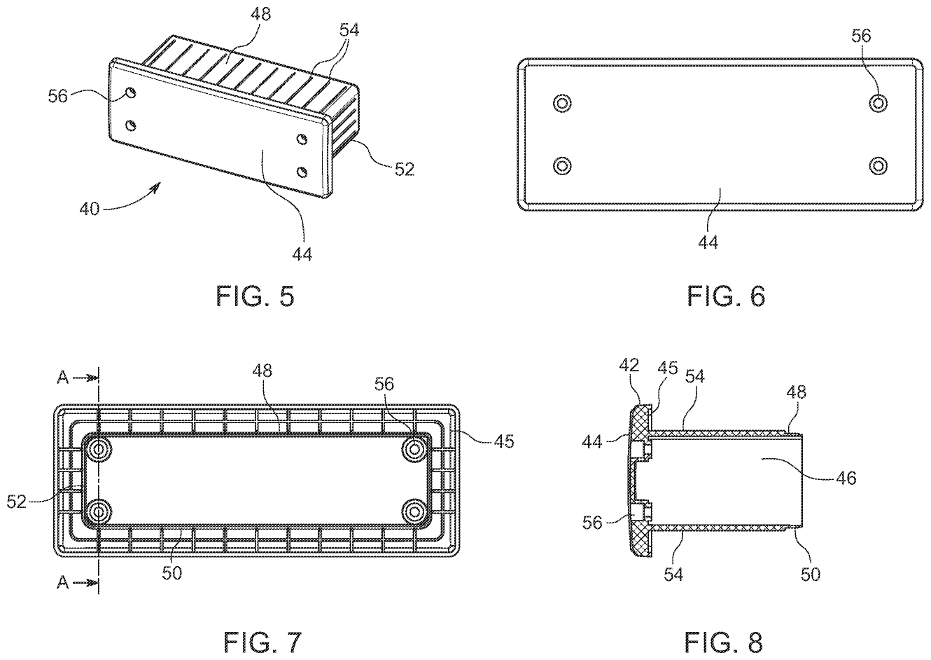

FIGS. 5-8 show a cover unit 40 that can be used to cover the docking unit 10 after it has been installed in a wall, but before it is configured with a charging unit. The cover unit 40 is designed to slot into the open front face of the docking unit 10 so as to close off the hollow body 12 from the outside. The cover unit 10 has a front plate 42 having an outward facing front surface 44 which can be provided with a decorative panel, and a rear surface that is designed to face the wall and which has a cover unit hollow body 46 extending to the rear. The front plate 42 defines a flange 45 around the outside of the hollow body 46. The hollow body 46 is open to the rear.

The top 48, bottom, 50, and sides 52 are provided with a series of ridges 54 running front to rear. The dimensions around the outside of the ridges 54 are such that when the cover hollow body 46 is inserted into the docking unit hollow body, the ridges 54 form a friction fit with the inside of the docking unit 10.

Through holes 56 are provided in the front plate 42 that lead into the corners of the hollow body 46 and, when the cover unit 40 is slotted into the docking unit 10, the through holes 56 are aligned with the anchor formations 28 so that locating screws (not shown) can be used to secure the cover unit 40 to the docking unit 10. In this configuration, the flange 45 of the front plate 42 extends over the open end of the docking unit 10 and any surrounding joints in the block wall.

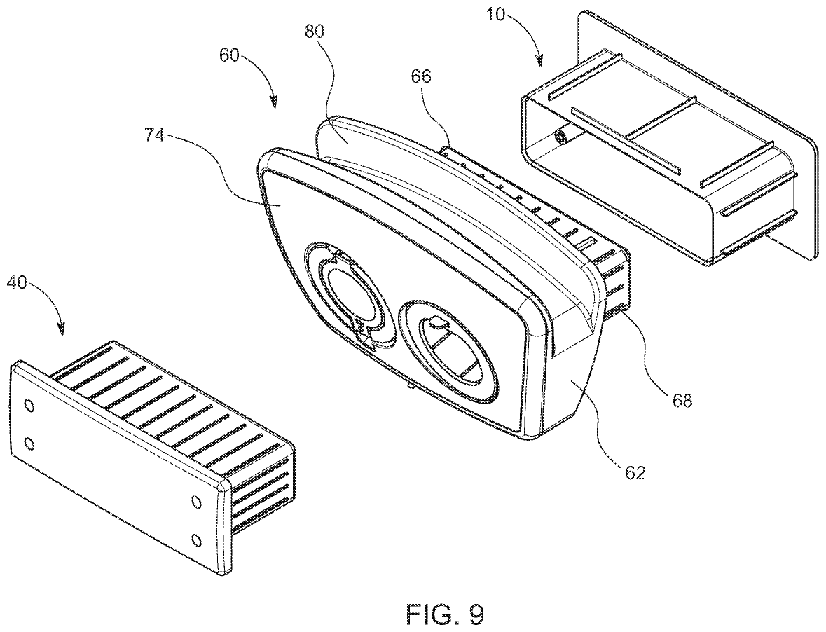

When it is desired to provide charging (or other future) capability at the location of interest, the locating screws can be removed and the cover unit 40 can be removed from the docking unit 10 and a charging unit 60 can be slotted into the docking unit 10 (see FIG. 9).

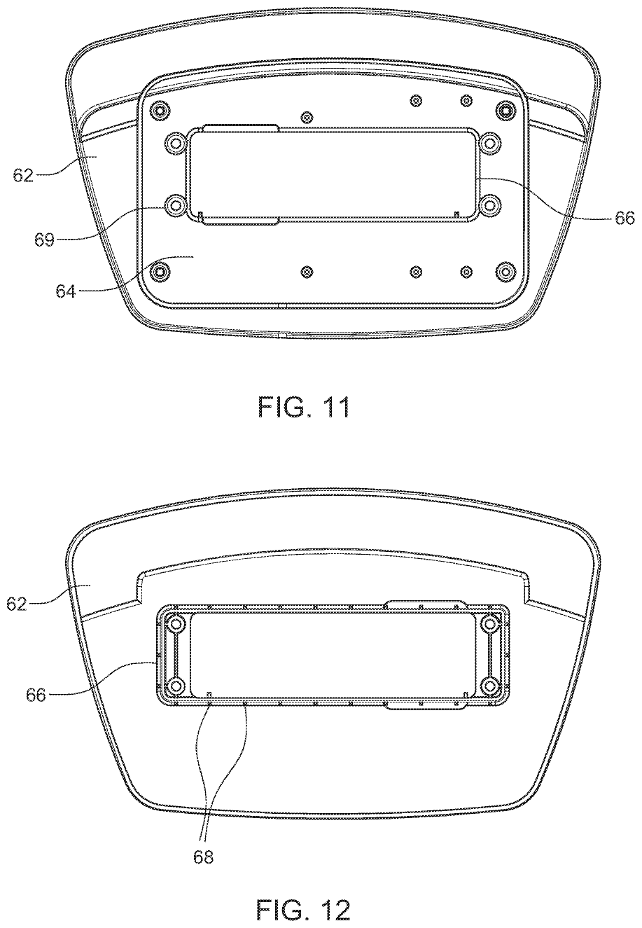

As shown in FIGS. 11 and 12, the charging unit 60 has a front section 62 having an outward facing cavity 64 and a rearwardly extending a hollow body 66 which is open at both ends. The hollow body 66 has external ridges 68 extending front to rear. The dimensions of the hollow body 66 and ridges 68 are similar to those of the cover unit 40 and provide a friction fit into the hollow body 12 the docking unit 10 in a similar manner. The charging unit also has through holes 69 aligned with the anchor formations 28 of the docking unit 10 so that locating screws (not shown) can be used to secure the charging unit 60 to the docking unit 10. In this configuration, the front section 62 will extend over the open end of the docking unit 10 and any surrounding joints.

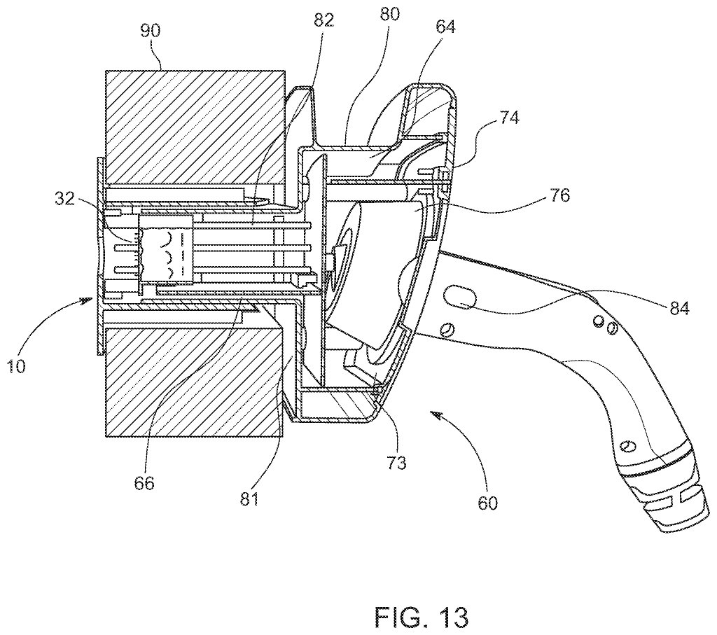

A charger module (shown in more detail in FIG. 13) is located in the hollow body 66. The rear of the charger module has a series of contacts that are complimentary to the contacts on the electrical connector module 29. Insertion of the charging unit 60 into the docking unit 10 brings these contacts into engagement with each other so that the charger module is electrically connected to an electrical supply via the cable which is connected to the consumer supply.

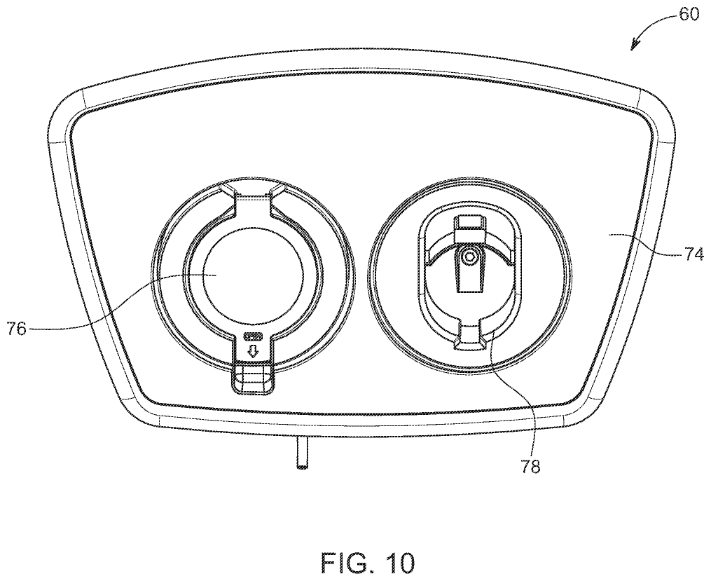

The front of the cavity 64 is closed by a cover 73 as shown in FIGS. 10 and 13. The cover 74 has a charging socket 76 which is connected to the charger module so that one end of a charging cable (not shown) can be connected to the charging module to supply electrical power to charge an electric vehicle (not shown). A locating socket 78 is provided alongside the charging socket 76. The locating socket 78 has no electrical connections but allows the other end of the charging cable to be stowed to the charger module in a safe and tidy manner when not being used to charge the vehicle. The locating socket may be replaced by a second charging socket. A decorative cover 74 is mounted over the front part of the cover 73.

The top of the front section 62 is configured as a channel 80 which allows the charging cable to be wrapped around the front section 62 when not in use. In this way the cable can be stored safely without leaving a trip hazard or being accidentally damaged.

FIG. 13 shows a section through the charging unit 60 and docking unit 10 installed in a wall 90. The charging socket 76 is connected to charging control module 81 mounted in the cavity 64 and extending into the hollow body 66.

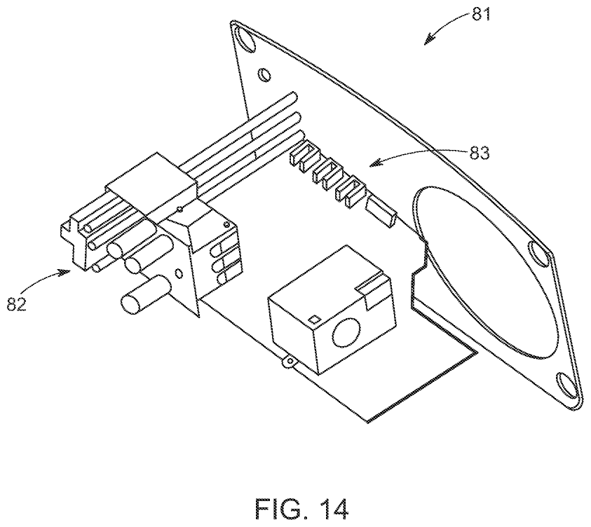

The charging control module 81 is shown in more detail in FIG. 14 and includes contacts 82 that engage into the docking unit contacts 32. The control module 81 includes electronic boards 83 that manage the provision of electrical power from the domestic supply via the connector module 29 to a vehicle when a charge cable 84 is inserted into the charging socket 76 to engage the control module 81.

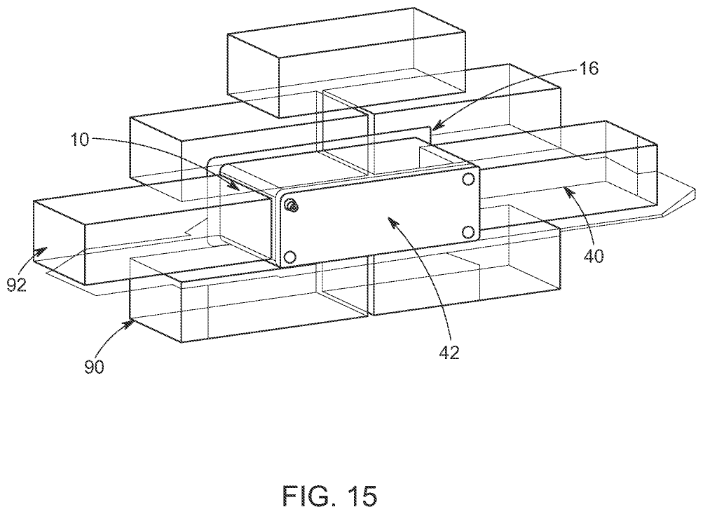

FIG. 15 shows the docking unit 10 closed by a cover unit 40 installed in the outer wall 90 of a cavity wall of brick construction. The inner wall 92 is spaced behind the outer wall 90. In this case, both walls 90, 92 are shown of brick construction but it is also possible that the outer and inner walls may be constructed using different techniques. Because the ridges 22 are lower than the flange 16, the joint between the docking unit and adjacent blocks can be smaller than the extent of the flange 16. As can be seen, the back-plate flange 16 of the docking unit 10 overlaps the surrounding joint and parts of the surrounding bricks. This helps hold the docking unit in place and helps prevent the docking unit 10 from being pulled out of the wall when the cover unit 40 (or the charging unit 60) is removed. The front plate 42 of the cover unit 40 likewise covers at least part of the joints and surrounding bricks.

In many types of house construction, electrical power cables are run through the cavity between the inner and outer walls. This makes it relatively straightforward to feed the supply cable into the docking unit 10 as described above.

By making the size of the hollow bodies approximately the same as that of a brick or block, the basic design and construction of the wall does not need to be changed in order to locate the docking unit. Furthermore, the docking unit can be installed in the wall in the same way as any other block or brick, using mortar joints.

While the invention has been described in the context of brick or block walls, it can be used in other types of wall construction such as timber or panel walls.

Furthermore, the docking unit could be used to mount other devices as future accessories than a charger unit.

Seals or gaskets can be provided on the cover unit or charging unit to provide a seal with the docking unit and prevent water or other materials from entering the hollow body.

Various changes can be made to the system described above while remaining within the scope of the invention.

1. A docking unit for mounting in a block wall, comprising:
a docking unit hollow body for incorporation into a block wall, the docking unit hollow body having a substantially rectangular profile with first opposed walls, second opposed walls, an open face, and a closed face, wherein:
the outer surfaces of the first opposed walls each have a plurality of upstanding ridges, each ridge extending in a face to face, or side to side direction,
the closed face of the docking unit hollow body is closed by a back plate having an opening to allow an electric supply cable to be fed into the docking unit hollow body, and
the backplate defines a flange extending around the outside of the docking unit hollow body beyond the first and second opposed walls, wherein the flange stands further from the first and second opposed walls than the upstanding ridges; and
an electrical connector positioned within the docking unit hollow body and having connectors for connection to the electric supply cable, and contacts for connection to a charging unit.

2. A docking unit as claimed in claim 1, wherein the outer surfaces of the second opposed walls also have a plurality of upstanding ridges extending in a face-to-face direction.

3. A docking unit as claimed in claim 1, wherein the docking unit hollow body has dimensions corresponding to that of blocks in the block wall.

4. A docking unit as claimed claim 1, wherein the hollow body further comprises anchor points to which a cover unit or charging unit can be secured.

5. A docking unit as claimed in claim 4, wherein the anchor points comprise screw anchors located in the corners of the docking unit hollow body.

6. A docking unit as claimed in claim 1, wherein the electrical connector opening in the back plate is offset to one side of the back plate and the electrical connector is offset to the other side of the back plate.

7. A docking unit as claimed in claim 1, wherein the contacts of the electrical connector for connection to a charging unit face the open front face of the docking unit hollow body.

8. A cover unit for use with a docking unit as claimed in claim 1, comprising:
a cover unit hollow body for insertion into the docking unit hollow body through the open face, the cover unit hollow body having a substantially rectangular profile with first opposed walls, second opposed walls, an open face, and a closed face, wherein:
the outer surfaces of the first and second opposed walls have aligned upstanding ridges extending in a direction from the closed face towards the open face, and
a front plate defines the closed face and provides a flange extending around the cover unit hollow body beyond the first and second opposed walls of the cover unit hollow body, wherein the flange extends further from the first and second opposed walls than the upstanding ridges;
wherein, when the cover unit hollow body is inserted into the docking unit hollow body:
the aligned ridges on the walls of the cover unit hollow body engage inner surfaces of the docking unit hollow body first and second opposed walls; and
the docking unit electrical connector extends into the cover unit hollow body through the open face.

9. A cover unit as claimed in claim 8, further comprising a decorative panel on an outer surface of the front plate.

10. A cover unit as claimed in claim 8, wherein the front plate comprises locating holes for alignment with anchor points in the docking unit.

11. A charging unit for use with a docking unit as claimed in claim 1, comprising:
a charging unit hollow body for insertion into the docking unit hollow body through the open face, the charging unit hollow body having first opposed walls, second opposed walls, an open face, and a closed face including an opening into the charging unit hollow body, wherein:
the outer surfaces of the first and second opposed walls each have a plurality of aligned upstanding ridges extending from the closed face towards the open face, and
the closed face is closed by a front plate that includes a charger housing extending beyond the first and second opposed walls of the cover unit hollow body; and
a charger module is located in the charger housing and extends through the opening in the front plate into the charging unit hollow body, the charging module including contacts for connecting to the docking unit electrical connector, and a cable connector for connecting a charging cable;
wherein, when the charging unit hollow body is inserted into the docking unit hollow body:
the aligned ridges engage inner surfaces of the docking unit hollow body first and second opposed walls;
the docking unit electrical connector extends into the cover unit hollow body through the open face; and
the charger module contacts engage the contacts on the docking unit electrical connector.

12. A charging unit as claimed in claim 11, wherein the front plate includes a channel for holding a charging cable.

13. A charging unit as claimed in claim 11, wherein the front plate comprises two outward facing sockets, one for connection of one end a charging cable to the charger module, and the other for stowing the other end of the charging cable to the charging unit when not in use.

14. A charging unit as claimed in claim 11, wherein the front plate comprises locating holes for alignment with anchor points in the docking unit.

15. (canceled)

16. An apparatus, comprising:
(a) a docking unit, comprising:
a docking unit hollow body having a substantially rectangular profile with first opposed docking unit walls, second opposed docking unit walls, an open docking unit face, and a closed docking unit face, wherein:
the outer surfaces of the first opposed docking unit walls each have a plurality of docking unit upstanding ridges, each ridge extending in a face to face, or side to side direction,
the closed docking unit face of the docking unit hollow body is closed by a docking unit back plate having a docking unit opening to allow an electric supply cable to be fed into the docking unit hollow body, and
the docking unit back plate defines a flange extending around the outside of the docking unit hollow body beyond the first and second opposed docking unit walls,
wherein the docking unit flange stands further from the first and second opposed docking unit walls than the docking unit upstanding ridges; and
a docking unit electrical connector positioned within the docking unit hollow body and having connectors for connection to the electric supply cable, and contacts
(b) a cover unit hollow body for insertion into the docking unit hollow body through the docking unit open face, the cover unit hollow body having a substantially rectangular profile with first opposed cover unit walls, second cover unit opposed walls, an open cover unit face, and a closed cover unit face, wherein:
the outer surfaces of the first and second opposed cover unit walls have aligned upstanding cover unit ridges extending in a direction from the closed cover unit face towards the open cover unit face, and
a cover unit front plate defines the closed cover unit face and provides a cover unit flange extending around the cover unit hollow body beyond the first and second opposed cover unit walls of the cover unit hollow body, wherein the cover unit flange extends further from the first and second opposed cover unit walls than the upstanding cover unit ridges;
wherein, when the cover unit hollow body is inserted into the docking unit hollow body:
the aligned cover unit ridges on the cover unit walls of the cover unit hollow body engage inner surfaces of the docking unit hollow body first and second opposed docking unit walls;
the docking unit electrical connector extends into the cover unit hollow body through the cover unit open face; and
(c) a charging unit hollow body for insertion into the docking unit hollow body through the open docking unit face, the charging unit hollow body having first opposed charging unit walls, second opposed charging unit walls, an open charging unit face, and a closed charging unit face including a charging unit opening into the charging unit hollow body, wherein:
the outer surfaces of the first and second opposed charging unit walls each have a plurality of aligned upstanding charging unit ridges extending from the closed charging unit face towards the open charging unit face, and
the closed charging unit face is closed by a front charging unit plate that includes a charger housing extending beyond the first and second opposed cover unit walls of the cover unit hollow body; and
a charger module is located in the charger housing and extends through the charging unit opening in the front charging unit plate into the charging unit hollow body, the charging module including contacts for connecting to the docking unit electrical connector, and a cable connector for connecting a charging cable;
wherein, when the charging unit hollow body is inserted into the docking unit hollow body:
the aligned charging unit ridges engage inner surfaces of the docking unit hollow body first and second opposed docking unit walls;
the docking unit electrical connector extends into the cover unit hollow body through the open cover unit face; and
the charger module contacts engage the contacts on the docking unit electrical connector.

17. A method of installing a charging system using the apparatus of claim 16, comprising:
constructing a block wall from a series of blocks;
installing the docking unit in the wall in place of a block;
feeding an electrical supply cable through the docking unit opening in the docking unit back plate and connecting the electrical cable to the connectors of the electrical connector in the docking unit;
attaching the cover unit to the open docking unit face of the docking unit;
removing the cover unit from the docking unit; and
attaching the charging unit to the docking unit so that the charger module contacts engage the contacts on the docking unit electrical connector.
